(19) United States
(12) Patent Application Publication
(10) Pub. No.: US 2025/0300485 A1
(43) Pub. Date: Sep. 25, 2025

(54) CHARGING CASE

(71) Applicant: The Coleman Company, Inc., Wichita, KS (US)

(72) Inventors: Matthew G. Law, Wichita, KS (US); Carson Hawkes, Portage, MI (US)

(21) Appl. No.: 18/862,357

(22) PCT Filed: May 5, 2023
(86) PCT No.: PCT/US2023/066654

§ 371 Date: Nov. 1, 2024

Related U.S. Application Data
(60) Provisional application No. 63/364,217, filed on May 5, 2022.

(51) Int. Cl. H02J 7/35; A45C 15/06; F21L 4/08; H02J 7/00; H02J 50/10

(52) U.S. Cl. CPC H02J 7/35; A45C 15/06; F21L 4/085; H02J 7/0044; H02J 7/0047; H02J 50/10

(57) ABSTRACT

A solar charging case for recharging a headlamp powered by a rechargeable battery is provided. The solar charging case includes a solar panel positioned and located on an exterior surface of a body of the charging case. The solar panel is configured to receive solar energy from sunlight and/or another light source and convert the solar energy into electricity. The solar energy is communicated from the charging case to the headlamp to recharge the headlamp, for example via a wireless charging connection or a wired charging connection.

### CROSS-REFERENCE TO RELATED APPLICATIONS

This Application claims priority to U.S. Provisional Patent Application Ser. No. 63/364,217, filed on May 5, 2022, entitled “CHARGING CASE,” currently pending, the entire disclosure of which is incorporated herein by reference.

### FIELD OF INVENTION

The present invention relates generally to a charging case and more specifically to a solar energy powered charging case for charging a headlamp.

### BACKGROUND OF INVENTION

Many consumers engage in outdoor activities (e.g., camping, hiking, spelunking) in locations where electricity is scarce or not available at all. During these activities, consumers must rely on devices that either do not use electricity as a source of power or that include their own source of electricity. Further, because many of these recreational activities take place in poor lighting conditions, consumers may also require a source of light for their safety and enjoyment. As such, consumers often turn to battery-powered headlamps while taking part in such activities. The headlamps typically include a band or a strap that allows the consumer to temporarily affix the headlamp to his or her head and a light source (e.g., an incandescent bulb or LED light) that illuminates an area in front of the wearer when the headlamp is turned on.

Traditionally, headlamps were powered by disposable batteries. However, disposable batteries present various issues for consumers when the batteries are depleted. For example, it can be inconvenient to replace the batteries in a traditional headlamp, particularly if the headlamp's battery compartment is secured via attachment members such as screws. Moreover, the consumer must pack extra disposable batteries to replace the depleted batteries after use in the headlamp. Finally, using disposable batteries is harmful to the environment because disposable batteries contain harsh acids, and the disposable batteries are thrown away after use.

More recently, headlamps have included rechargeable batteries that may be “built-into” or integrated with the headlamps, eliminating the need for consumers to pack extra batteries or dispose of used batteries. Unfortunately, such rechargeable batteries require an external energy source to recharge, which can be particularly difficult in remote locations away from sources of electricity. Further, the headlamp is exposed to environmental conditions (e.g., sunlight, snow, rain) when the headlamp is connected to the external energy source, and it is easy for a cord connecting the external energy source and the battery to snag on another item. Both of these factors increase the risk that the headlamp will be damaged during the charging process.

### SUMMARY OF INVENTION

The present invention overcomes many of the shortcomings and limitations of the prior art devices discussed above. The invention described includes several embodiments of a charging case configured to charge a rechargeable battery in a rechargeable device such as a headlamp. The charging case may include a solar panel that captures solar energy, and the charging case may be configured to communicate the solar energy to the headlamp as electricity during the charging process. This eliminates the need for an external electricity source to charge the headlamp. In addition, the charging case may house the headlamp during charging. This may help protect the headlamp from damage from environmental factors (e.g., rain, snow, sunlight) and accidents (e.g., the user dropping the headlamp or a charging cord snagging) while the headlamp is charging.

The headlamp may be charged in at least one charging mode. For example, in a first charging mode, the headlamp may be inserted into the solar charging case, and the rechargeable battery of the headlamp may be charged via an electrical connection (e.g., via direct coupling of the headlamp and case or via an inductive charging module) established between the solar charging case and the headlamp. In a second charging mode, the solar charging case may be connected to an external energy source via a port positioned and located on an outer surface of the case. In the second charging mode, the external energy source may supply electricity to the case, which may provide power to the headlamp. In a third charging mode, the headlamp may be charged separately from the case and directly via an external cord that couples to the headlamp by way of a charging port positioned on the headlamp. The external energy source may provide electricity to the charging port which may, in turn, provide the electricity to the headlamp. The aforementioned external energy source may take a variety of forms, including an external battery, a laptop computer, a mobile device, a USB port, and/or an electrical receptacle.

These and other aspects and advantages of the present invention will become apparent to those skilled in the art after considering the following detailed description in connection with the accompanying drawings.

### BRIEF DESCRIPTION OF DRAWINGS

FIG. 1 is a top perspective view of a solar charging case constructed according to the teachings of the present invention;

FIG. 2 is a bottom perspective view of the solar charging case of FIG. 1, the solar charging case in an open position with a headlamp received therein;

FIG. 3 is another perspective view of a top portion of the solar charging case of FIG. 2;

FIG. 4 is a bottom perspective view of the headlamp of FIG. 2;

FIG. 5 is a plan view of an external cord couplable to the headlamp of FIG. 2; and

FIG. 6 is a schematic representation of a method for charging a headlamp.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

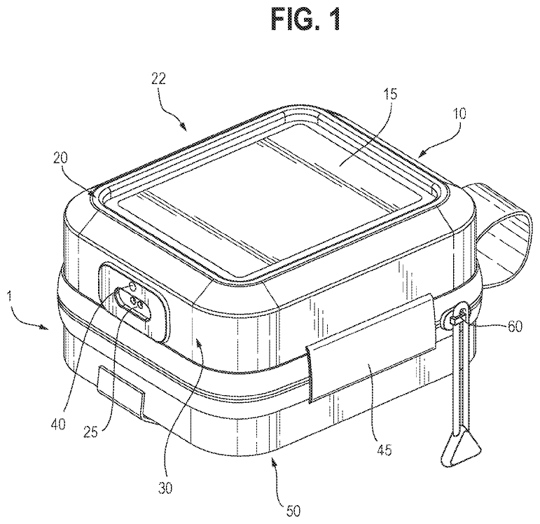

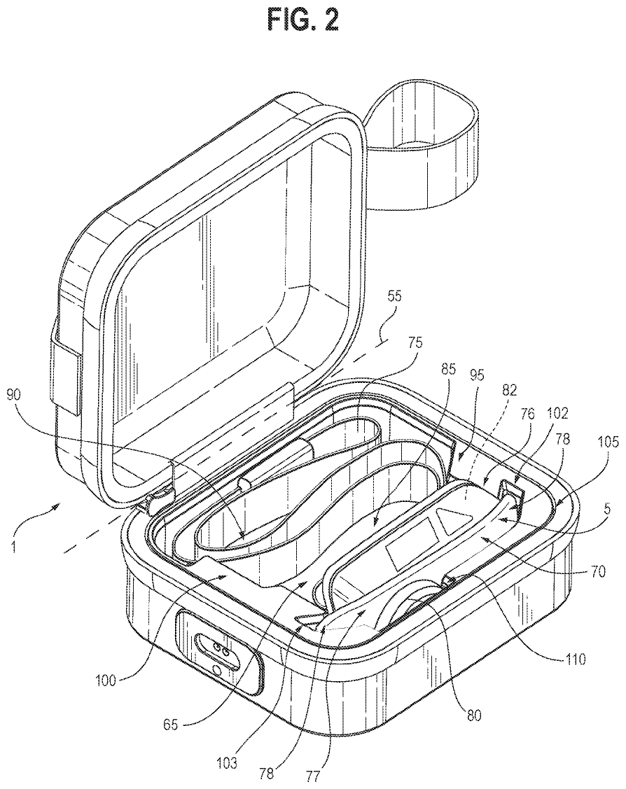

A solar charging case 1 (a “charging case 1”) is provided in FIG. 1 in which a headlamp 5 (see FIG. 2) or another rechargeable device may be secured and/or charged. The charging case 1 may have a body 10 provided substantially in the form of a rectangular prism with rounded corners, although other shapes for the body 10 are foreseeable. The body 10 may be composed of a durable plastic, nylon, metal, and/or another suitable material, as would be appreciated by those skilled in the art.

A solar panel 15 may be coupled or affixed to an exterior surface 20 of an upper portion 22 of the body 10 of the charging case 1, although other positions for the solar panel 15 are foreseeable. The solar panel 15 may comprise photovoltaic cells (e.g., silicon-based photovoltaic cells), a transparent element (e.g., glass) covering the photovoltaic cells, and circuitry electrically coupling the photovoltaic cells, although other suitable materials and structures for the solar panel 15 are foreseeable. Through known mechanisms, the solar panel 15 may collect solar energy (whether from sunlight or artificial light sources) and convert the solar energy into electricity. As will be further described herein, the electricity generated by the solar panel 15 may be communicated to a rechargeable battery of a rechargeable device (e.g., the headlamp 5) such that the rechargeable battery may be recharged. In alternative embodiments, the size and composition of the solar panel 15 may be adapted such that the solar panel 15 is capable of harvesting more energy or less energy from the light absorbed by the solar panel 15.

The charging case 1 may further include a port 25. The port 25 may be positioned and located on a side surface 30 of the upper portion 22 of the body 10, although one skilled in the art would appreciate that the port 25 may be located elsewhere on the body 10. The port 25 may be configured as a first connector capable of receiving and engaging a second connector. Traditionally, the port 25 could be considered a female connector adapted to receive a male connector. The second connector, if coupled to a source of electrical power, may supply electrical power to the charging case 1 via the port 25. The source of electrical power may be an external battery, a laptop computer, a mobile device, a USB port, an electrical receptacle, or any other item capable of supplying energy via the second connector.

When the charging case 1 supplies power to a rechargeable device or a rechargeable battery, an indicator light 40 may activate. The light 40 may be positioned and located on the side surface 30 of the upper portion 22 of the charging case 1, although other locations for the light 40 are foreseeable. While only a single light 40 is provided in the illustrated embodiment, more or fewer lights 40 could also be provided in other embodiments of the invention. The light 40 may provide the user with a visual cue that may help the user to determine when the rechargeable device is being recharged. Alternatively, or in addition, the light 40 may indicate whether the rechargeable device is receiving power from the solar panel 15, the port 25, or a combination thereof. For example, the light 40 may turn on to indicate that the rechargeable device is charging, and/or the color of the light 40 may indicate the source of the power being supplied to the rechargeable device. As an additional example, the light 40 may turn on and off (e.g., blink) at different frequencies to indicate the source of the power being supplied to the rechargeable device or the rate at which the rechargeable device is charging.

The body 10 may be selectively opened and closed by a user for storing the rechargeable device (e.g., the headlamp 5) and/or removing the rechargeable device contained therein. To assist the user in opening and closing the charging case 1, a hinge 45 may be coupled to the upper portion 22 and a lower portion 50 of the body 10. The hinge 45 may define a hinge axis 55 (see FIG. 2) about which the portions 22, 50 can rotate towards and away from one another. Thus, the hinge 45 may help the user to open and close the charging case 1 such that the user may access or isolate the interior of the charging case 1 more easily.

The charging case 1 may also include a mechanism 60 that may allow the user to selectively secure or latch the charging case 1 closed. For example, the mechanism 60 may be configured as a zipper positioned and located on the body 10 of the case (as illustrated), a latch mechanism, a hook-and-loop mechanism, or other similar mechanisms that are known in the art.

Turning to FIG. 2, when the charging case 1 is in an open position (as illustrated), an interior 65 of the charging case 1 may be accessible such that a user may remove or insert the headlamp 5 (or another rechargeable device). The headlamp 5 may be provided in the form of a lamp portion 70 and a band 75 attached thereto. The lamp portion 70 may be provided as a body portion 76 substantially in the shape of a rectangular prism with rounded edges that is coupled to a front plate 77. The front plate 77 may be provided as an elongated rectangular prism with inwardly curving ends 78. A lens assembly 80 may be positioned and located on the front plate 77. The lens assembly 80 may be located closer to either of the ends 78, or the lens assembly 80 may be located approximately equidistant from the ends 78 on the front plate 77. The lens assembly 80 may emit light using one or more light sources (not illustrated) that receive electrical power from a rechargeable battery 82 housed within the body portion 76. As would be appreciated by those having skill in the art, virtually limitless different shapes and configurations of the lamp portion 70 and/or its constituent components may be provided in alternative embodiments of the invention.

The rechargeable battery 82 may be provided as any type of battery that is capable of being discharged and subsequently recharged by an external power source. For example, the rechargeable battery 82 may be provided as a lithium ion battery, a nickel cadmium battery, and/or a nickel-metal hydride battery. Preferably, the rechargeable battery 82 is provided as a lithium ion battery.

The band 75 of the headlamp 5 may be a flexible elastomeric loop coupled to the lamp portion 70, although other forms for the band 75 are foreseeable. As a result, the user may wear the headlamp 5 by placing the band 75 around their body to obtain light in a hands-free manner (i.e., without the user physically holding the headlamp 5).

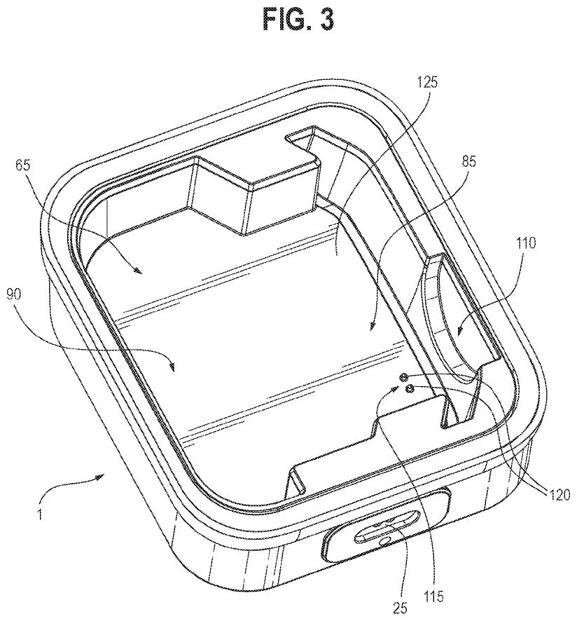

To assist the user in placing the headlamp 5 in the charging case 1, the interior 65 may include a first section 85 and a second section 90. The first section 85 may be sized and shaped to receive the lamp portion 70 of the headlamp 5, and the second section 90 may be sized and shaped to receive the band 75 of the headlamp 5. For example, the first section 85 may include a first protrusion 95 and a second protrusion 100. The first and second protrusions 95, 100 may be positioned and located at an outer circumference 105 circumscribing the interior 65, and the first and second protrusions 95, 100 may extend inwardly from the outer circumference 105 and into the interior 65. The first and second protrusions 95, 100 may be configured such that the size and shape of the first section 85 generally mirrors the size and shape of the lamp portion 70. For example, the first protrusion 95 may include a first cut-out or a first opening 102 extending into the first protrusion 95 and towards the outer circumference 105, and the second protrusion 100 may include a second cut-out or a second opening 103 extending into the second protrusion 100 and towards the outer circumference 105. The first opening 102 and the second opening 103 may be sized and shaped to receive the ends 78 of the front plate 77. In addition, the first section 85 of the interior 65 may include a pocket 110 (further illustrated in FIG. 3). The pocket 110 may be sized and shaped for receiving the lens assembly 80 of the headlamp 5.

In some embodiments, the interior 65 may also include a divider or a wall portion to separate the lamp portion 70 from the band 75 when the headlamp 5 is received within the interior 65. In other embodiments, the interior 65 may not include the first and second protrusions 95, 100 or the pocket 110. In such embodiments, the interior 65 may be provided in a generally symmetrical shape wherein the first and second sections 85, 90 substantially mirror each other.

Turning to FIG. 3, when the headlamp 5 is received in the charging case 1, the headlamp 5 may be placed into electrical communication with the charging case 1. The charging case 1 may include a first charging connection 115 positioned and located in the first section 85 of the charging case 1. The first charging connection 115 may include at least one prong 120 extending upwardly and away from a surface 125 of the interior 65, and the at least one prong 120 may be configured to be received by the headlamp 5. In alternative embodiments, the first charging connection 115 may be located elsewhere in the interior 65, and/or the first charging connection 115 may be provided as another structure configured to establish electrical communication with the headlamp 5.

The first charging connection 115 may be in electrical communication with at least one of the solar panel 15 (see FIG. 1) and the port 25. Thus, the first charging connection 115 may provide electrical energy from the solar panel 15, the port 25, or a combination thereof. For example, in a first charging mode of the headlamp 5, the headlamp 5 may be stored in the charging case 1 to receive electrical energy from the solar panel 15, while in a second charging mode, the headlamp 5 may be stored in the charging case 1 to receive electrical energy from the port 25. The mechanisms by which the energy is transmitted to the first charging connection 115 from the solar panel 15 and the port 25 are known in the art.

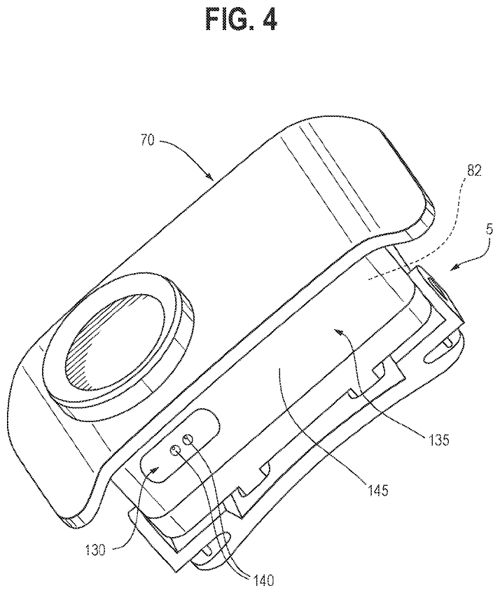

Turning to FIG. 4, a second charging connection 130 may be positioned and located on a lower surface 135 of the headlamp 5. The second charging connection 130 may be positioned on the lamp portion 70 of the headlamp 5 such that when the headlamp 5 is received in the charging case 1, the second charging connection 130 is preferably in contact with the first charging connection 115 (see FIG. 3). Additionally, the first and second charging connections 115, 130 may include magnets (not illustrated) configured to establish a magnetic connection between the first and second charging connections 115, 130. For example, when the first and second charging connections 115, 130 are placed in proximity, the force of the magnetic attraction between the magnets may exceed a threshold force, and the magnetic connection may be established. The magnetic connection may assist the user in placing the first and second charging connections 115, 130 in contact with one another and/or help hold the charging connections 115, 130 in contact with one another.

The second charging connection 130 may include at least one receptor 140 (two receptors 140 are illustrated in FIG. 4). The receptors 140 may be small, open cylinders extending into the second charging connection 130. In some embodiments, the shape of the receptors 140 may generally mirror the shape of the prongs 120. Accordingly, when the headlamp 5 is received in the charging case 1, the prongs 120 of the first charging connection 115 may extend into the receptors 140 to establish electrical communication between the first and second magnetic charging connections 115, 130. The second charging connection 130 may also be in electrical communication with the rechargeable battery 82 housed in a battery compartment 145 of the headlamp 5. As a result, the energy received from the charging case 1 may be transferred as electricity from the second charging connection 130 to the rechargeable battery 82 to replenish the rechargeable battery 82.

In some embodiments, the first and second charging connections 115, 130 may transfer energy from the charging case 1 to the headlamp 5 via other methods. For example, in some embodiments, the first and second charging connections 115, 130 may be provided as wireless charging modules (e.g., inductive charging modules). In such embodiments, energy from the first charging connection 115 may be transmitted to the second charging connection 130 via electromagnetic waves. Accordingly, the first and second charging connections 115, 130 need not abut one another for charging to occur. Instead, charging may occur when the charging connections 115, 130 are in physical proximity.

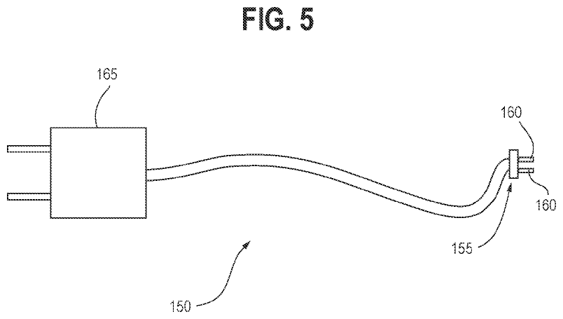

Turning next to FIG. 5, an external cord 150 configured to engage with at least one of the charging case 1 (see, e.g., FIG. 1) and the headlamp 5 (see, e.g., FIG. 4) is provided. For example, an end 155 of the external cord 150 may be provided as an electrical connector with prongs 160 designed to engage with the port 25 on the charging case 1 and with the receptors 140 on the headlamp 5. In addition, the external cord 150 may be couplable to a source of electricity (e.g., an external battery, a laptop computer, a mobile device, a USB port, an electrical receptacle) by a plug 165 (e.g., a NEMA 1-15 plug, a USB plug). Thus, electricity may be supplied to the charging case 1 or the headlamp 5 via the external cord 150. For example, in the second charging mode, the plug 165 may be coupled to a source of electricity, the end 155 may be coupled to the port 25 on the charging case 1, and the headlamp 5 may be received in the charging case 1. Accordingly, the external cord 150 may deliver electricity to the charging case 1, and in turn, the charging case 1 may communicate the electricity to the headlamp 5.

In the third charging mode, the end 155 of the external cord 150 may be coupled directly to the receptors 140 of the headlamp 5. More particularly, the prongs 160 of the external cord 150 may be received and engaged by the receptors 140 on the headlamp 5. As a result, electrical communication may be established between a source of electricity and the headlamp 5. Thus, in the third charging mode, the headlamp 5 need not be placed into the charging case 1 for recharging to occur. Instead, electricity may be communicated directly to the headlamp 5 from an external source via the external cord 150.

While only three charging modes are described above, one skilled in the art will appreciate that additional modes or methods of charging the headlamp 5 may be available to the user. For example, in another charging mode, the charging case 1 may provide electrical energy from the solar panel 15 to a rechargeable device via the port 25. Thus, the rechargeable device may be external to the charging case 1 while receiving electrical energy from the solar panel 15. As an additional example, the charging case 1 may provide electrical energy to more than one rechargeable device at a time.

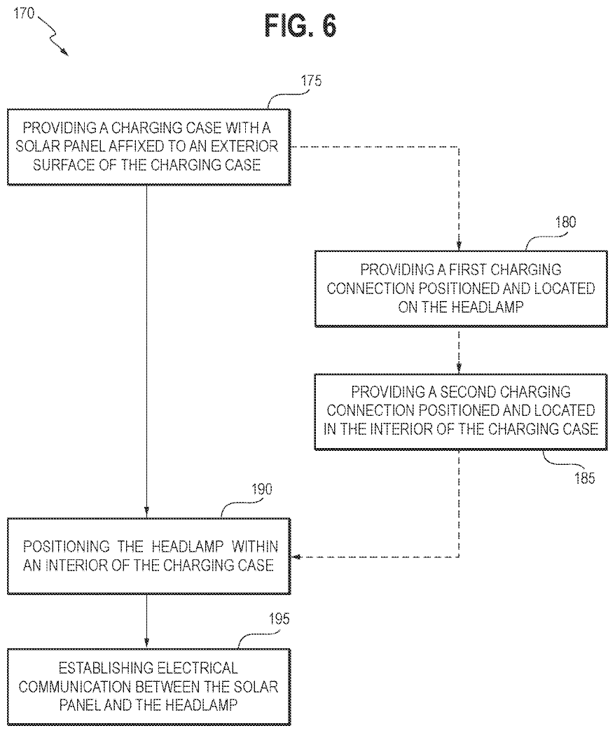

Referring to FIG. 6, a method 170 of charging a headlamp is illustrated. The method 170 may comprise a step 175 of providing a charging case with a solar panel affixed to an exterior surface of the charging case. The method 170 may also include an optional step 180 of providing a first charging connection positioned and located on the headlamp and an optional step 185 of providing a second charging connection positioned and located in the interior of the charging case. The method 170 may further include a step 190 of positioning the headlamp within an interior of the charging case. In some embodiments, the step 190 may further include rotating an upper portion of the charging case relative to a lower portion of the charging case to access the interior of the charging case. The method 170 may also include a step 195 of establishing electrical communication between the solar panel and the headlamp. In some embodiments, the step 195 may further include coupling the first and second charging connections together such that the electrical communication is established between the solar panel and the headlamp. In other embodiments of the step 195, electrical communication between the solar panel and the headlamp may be established when the first and second charging connections are proximate to one another.

In alternative embodiments of the method 170, the method 170 may further include a step of providing at least one indicator light positioned and located on the charging case. The at least one indicator light may activate when the solar panel is placed in electrical communication with the headlamp. In other embodiments, the method 170 may further include a step of providing a port positioned and located on the exterior surface of the charging case, a step of providing an external cord and attaching the external cord to the port, and a step of establishing electrical communication between the port and the headlamp. In yet other embodiments of the method 170, the interior of the charging case may include a first section configured to receive the lamp portion of the headlamp and a second section configured to receive a band portion of the headlamp. In other embodiments of the method 170, the interior of the charging case may include at least one protrusion extending into the interior of the charging case from an outer circumference of the charging case. In such embodiments, the at least one protrusion may be configured to abut the headlamp when the headlamp is received in the interior.

The method 170 further comprise additional steps consistent with the teachings disclosed herein. In addition, the method 170 may also comprise fewer steps than those described above.

As is evident from the foregoing description, certain aspects of the present invention is not limited by the particular details of the examples illustrated herein, and it is therefore contemplated that other modifications, applications, variations, or equivalents thereof, will occur to those skilled in the art. Many such changes, modifications, variations and other uses and applications of the present constructions will, however, become apparent to those skilled in the art after considering the specification and the accompanying drawings.

In addition, unless mention was made above to the contrary, it should be noted that all of the accompanying drawings are not to scale. All such changes, modifications, variations and other uses in applications which do not depart from the spirit and scope of the present inventions are deemed to be covered by the inventions which are limited only by the claims which follow.

1. A charging case comprising:
a body including:
a base;
a plurality of side portions extending upwardly and away from the base;
a cover portion coupled to at least one side portion of the plurality of side portions, the cover portion extending between the plurality of side portions; and
wherein the base and the plurality of side portions, and the cover portion define an interior space of the body;
a solar panel positioned and located on an exterior surface of the body;
a first charging connection positioned and located within the interior space; and
wherein the first charging connection and the solar panel are in electrical communication with one another.

2. The charging case of claim 1, wherein the interior space is adapted to receive a headlamp including a second charging connection, and wherein the first charging connection is adapted to interface with the second charging connection to establish electrical communication between the solar panel and the headlamp.

3. The charging case of claim 1 further comprising at least one indicator light, and wherein the at least one indicator light activates when the solar panel provides electrical energy to the first charging connection.

4. The charging case of claim 1 further comprising a port positioned and located on the body of the charging case, wherein the port is in electrical communication with the first charging connection.

5. The charging case of claim 4 further comprising at least one indicator light, wherein the at least one indicator light displays a first color when the solar panel is providing electrical energy to the first charging connection and a second color when the port is providing electrical energy to the first charging connection.

6. The charging case of claim 1, wherein the interior space comprises:
an outer circumference circumscribing the interior space;
a first section;
a second section; and
at least one protrusion extending from the outer circumference and into the first section of the interior space.

7. A headlamp charging system comprising:
a headlamp including:
a lamp portion configured to emit light from the headlamp;
a rechargeable battery in electrical communication with the lamp portion; and
a first charging connection in electrical communication with the rechargeable battery;
a charging case including:
a body including at least one exterior surface, the body defining an interior sized and shaped to receive the headlamp;
a second charging connection positioned and located in the interior;
a solar panel positioned and located on the at least one exterior surface;
wherein the solar panel is in electrical communication with the second charging connection; and
wherein, when the headlamp is received in the interior, the first charging connection is in electrical communication with the second charging connection.

8. The headlamp charging system of claim 7, wherein:
the first charging connection comprises at least one receptor extending into the headlamp;
the second charging connection comprises at least one prong extending outwardly from the charging case; and
wherein, when the headlamp is received in the interior of the charging case, the at least one receptor receives the at least one prong.

9. The headlamp charging system of claim 7, wherein, when the first charging connection and the second charging connection are in physical proximity, the first charging connection and the second charging connection are magnetically coupled to one another.

10. The headlamp charging system of claim 7, wherein:
the interior includes a first section and a second section;
the second charging connection is positioned and located in the first section; and
the first section is configured to receive the lamp portion of the headlamp and the second section is configured to receive a band of the headlamp.

11. The headlamp charging system of claim 7, wherein the body of the charging case further comprises an upper portion rotatably coupled to a lower portion, and wherein rotation of the upper portion away from the lower portion provides access to the interior.

12. The headlamp charging system of claim 7, wherein the charging case further comprises:
an upper portion;
a lower portion;
a mechanism configured to selectively couple the upper portion to the lower portion; and
wherein the mechanism is provided as at least one of a zipper apparatus, a latch apparatus, and a hook-and-loop apparatus.

13. The headlamp charging system of claim 7, wherein the first charging connection and the second charging connection each comprise inductive charging modules configured to transmit energy from the second charging connection to the first charging connection by way of electromagnetic waves.

14. A method for charging a headlamp powered by a rechargeable battery, the method comprising steps of:
providing a charging case with a solar panel affixed to an exterior surface of the charging case;
positioning the headlamp within an interior of the charging case; and
establishing electrical communication between the solar panel and the headlamp.

15. The method of claim 14, wherein positioning the headlamp within the interior of the charging case further includes a step of rotating an upper portion of the charging case relative to a lower portion to access the interior of the charging case.

16. The method of claim 14 further comprising steps of:
providing a first charging connection positioned and located on the headlamp;
providing a second charging connection positioned and located in the interior of the charging case; and
wherein establishing electrical communication between the solar panel and the rechargeable battery further includes a step of coupling the first charging connection and the second charging connection.

17. The method of claim 14 further comprising a step of providing at least one indicator light, the at least one indicator light positioned and located on the charging case, and wherein the at least one indicator light activates when the solar panel is placed into electrical communication with the headlamp.

18. The method of claim 14 further comprising steps of:
providing a port positioned and located on the exterior surface of the charging case;
providing an external cord and attaching the external cord to the port; and
establishing electrical communication between the port and the headlamp.

19. The method of claim 14, wherein:
the interior of the charging case further includes a first section and a second section;
the first section is configured to receive a lamp portion of the headlamp; and
the second section is configured to receive a band portion of the headlamp.

20. The method of claim 14, wherein the interior of the charging case further includes at least one protrusion extending into the interior of the charging case from an outer circumference of the charging case, the at least one protrusion configured to abut the headlamp when the headlamp is received in the interior.
